(19) United States
(12) Patent Application Publication
(10) Pub. No.: US 2019/0266626 A1
(43) Pub. Date: Aug. 29, 2019

(54) SYSTEMS, METHODS, AND APPARATUS FOR MANAGING AND PRESENTING DYNAMIC PRICING

(71) Applicant: Peter Khosla, Marion, IN (US)

(72) Inventor: Peter Khosla, Marion, IN (US)

(21) Appl. No.: 16/289,622

(22) Filed: Feb. 28, 2019

Related U.S. Application Data
(60) Provisional application No. 62/636,554, filed on Feb. 28, 2018.

(51) Int. Cl. G06Q 30/02; G06Q 30/06

(52) U.S. Cl. CPC G06Q 30/0206; G06Q 30/0239; G06Q 30/0641

(57) ABSTRACT

Dynamically displaying and managing the price of an item to be sold is achieved using a processor operative to execute instructions to provide an interface to a seller adapted to allow the seller to define an initial price for the item, price break points, and a sales campaign period; to provide an interface to buyers, the second interface adapted to allow a buyer to commit to purchasing the item at an initial price and a display to indicate a changing price of the item, a rate of change of the price relative to additional buyers committing to purchase the item, and a final price of the item at an end of the sales campaign period; and to provide a transaction system to charge financial instruments of the buyers to effect the sale of the item to the buyers at the final price.

### RELATED APPLICATION

This application claims the benefit of U.S. Provisional Application No. 62/636,554, filed Feb. 28, 2018, the entirety of which is incorporated herein for all purposes.

### FIELD

This disclosure relates to pricing products offered in a product sales campaign and, more particularly, to systems for managing and presenting dynamic prices.

### BACKGROUND

As the demand for a product increases, conventional economics teaches that the price also increases, particularly with “expiring” products with event dates like concert tickets or hotel rooms. However, as prices increase, many potential purchasers are precluded from being able to afford or cost justify the purchase. Not only does this fact negatively impact potential purchasers, but the seller may realize a smaller total profit since fewer units are sold, e.g., a concert does not sell out. There have been attempts to provide systems that offer products at discounted prices by aggregating purchasers to gain some assurance that higher numbers of a product will be sold. Groupon™ is an example of such a system. While in some cases such systems have had success, frequently these promotions do not result in increased profit for sellers. Thus, what is needed are systems, methods and apparatus to facilitate dynamically adjusted pricing during a sales promotion that ensures profits increase even as prices are reduced to encourage additional sales.

### SUMMARY

In some embodiments, a system for dynamically displaying and managing the price of an item to be sold is provided. The system includes a processor within an internet accessible server, the processor coupled to a memory, the memory operative to store instructions executable on the processor, the instructions including: provide a first interface to a seller adapted to allow the seller to define an initial price for the item, price break points, and a sales campaign period; provide a second interface to a plurality of buyers, the second interface adapted to allow a buyer to commit to purchasing the item at an initial price and a display to indicate a changing price of the item, a rate of change of the price relative to additional buyers committing to purchase the item, and a final price of the item at an end of the sales campaign period; and provide a transaction system to charge financial instruments of the plurality of buyers to effect the sale of the item to the plurality of buyers at the final price.

In some embodiments, a method of maximizing the profit earned during a sales campaign is provided. The method includes providing a first interface to a seller adapted to allow the seller to define an initial price for an item, price points, and a sales campaign period; providing a second interface to a plurality of buyers, the second interface adapted to allow a buyer to commit to purchasing the item at an initial price and a display to indicate a changing price of the item, a rate of change of the price relative to additional buyers committing to purchase the item, and a final price of the item at an end of the sales campaign period; providing a transaction system to charge financial instruments of the plurality of buyers for the item; and selling the item to the plurality of buyers at the final price.

Still other aspects, features, and advantages in accordance with these and other embodiments of the disclosure may be readily apparent from the following detailed description, the appended claims, and the accompanying drawings. Accordingly, the drawings and descriptions herein are to be regarded as illustrative in nature, and not as restrictive.

### BRIEF DESCRIPTION OF DRAWINGS

The drawings, described below, are for illustrative purposes only and are not necessarily drawn to scale. The drawings are not intended to limit the scope of the disclosure in any way.

FIG. 1 illustrates an example system for managing and presenting dynamic prices according to embodiments of the disclosure.

FIG. 2 illustrates an example application server for use in a system for managing and presenting dynamic prices according to embodiments of the disclosure.

FIG. 3 illustrates an example of a graphical user interface for defining a price ramp structure for use by a system for managing and presenting dynamic prices according to embodiments of the disclosure.

FIG. 4 illustrates a method of managing and presenting dynamic prices according to embodiments of the disclosure.

FIG. 5 illustrates an additional example of a system for managing and presenting dynamic prices according to embodiments of the disclosure.

FIG. 6 illustrates an example of a graphical user interface for presenting dynamic prices to users according to embodiments of the disclosure.

FIG. 7 illustrates an example of graphs depicting a number of items sold over time during a sales promotion during two different years according to embodiments of the disclosure.

### DESCRIPTION

In some embodiments, the present invention provides methods that allow the price of a product, service, or experience as displayed on a website, or e.g., on video signage, to drop to a lower price for all purchasers during a promotional period as the number of purchasers increases. The system provides the interfaces, databases, and system architecture for users and sellers to interact with the system to allow changes to the price and to commit to purchasing. In operation, using a novel interface, a purchaser commits to paying a currently indicated price knowing that (1) the price will continue to drop as additional buyers join the campaign, but (2) if nobody else joins, the purchaser remains obligated to purchase at the committed price.

In some embodiments, the system is operative to display via the interface the number of buyers required for the price to drop further (e.g., a next drop point) and the time remaining before the purchases will be fully processed (e.g., the remaining campaign time). Because all purchasers benefit from additional buyers joining, this method naturally causes tremendous organic marketing (e.g., word of mouth advertising by participants to try to get more participants) during the campaign. In some embodiments, the system is optimized to stimulate organic marketing. At the end of the campaign time, all purchasers will each pay the same amount, either directly or via refunds. Although in some embodiments, the seller can initially set all the parameters for the campaign including the starting price, the amount of time for the promotional campaign, and the various amounts of sales required for each drop point or price break, in other embodiments, the system provides the seller with an interface to allow the seller to set these parameters dynamically during the campaign or automatically in response to factors such as rate of purchase, changing product availability, or other factors.

During the campaign, in a very real sense, it is the buyers who determine the final selling price. This is a unique experience for a purchaser and causes a “stickiness” of the system in that users come back to the user interface of the platform multiple times during the campaign to see how far the price has dropped since their last visit, and perhaps to share it with a friend to “get the word out” even more, this can result in mass organic marketing or “going viral.” In some embodiments, the user interface includes buttons to enable users to easily share the progress of the price reduction and other promotional information via social media and messaging applications.

In some embodiments, the method (e.g., encoded and embodied in software) can be applied to an existing seller's website via a link that allows purchasers to make transactions without leaving the seller's site. Alternatively, sellers can send users to a dynamic price display site that implements the methods of the present invention.

In some embodiments, a graphical user interface (GUI) that implements a “slide calculator” is provided that includes a tool set within the dynamic price display method that helps the seller determine their optimal sales structure for price change increments. In some embodiments, a secondary dynamic price display interface can be implemented as a widget (e.g., GUI control) adapted to be integrated onto many different existing online sales platforms.

In some embodiments, a dynamic price display portal can be provided to aggregate several dynamic price displays by different sellers into a single site. In some embodiments, a mobile application is provided that offers a dedicated application for interacting with the dynamic price display interface. In some embodiments, a software widget is provided that allows a UPC barcode on the product to be scanned and the current price indicator is retrieved from a database for any sellers currently selling a matching UPC item using the dynamic price display system.

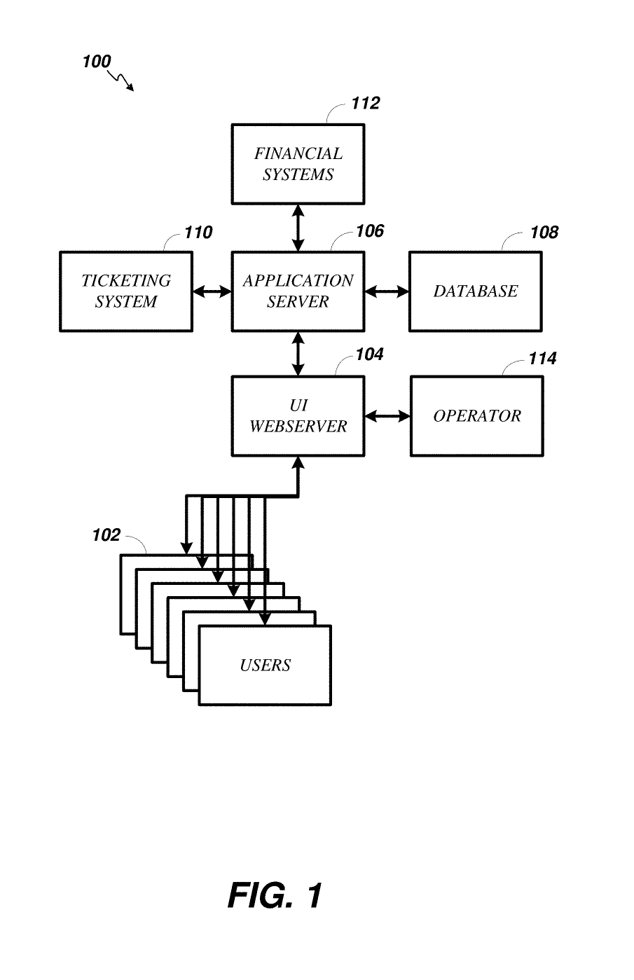

Turning to FIG. 1, an example embodiment of a system 100 for dynamically displaying and managing the price of an item to be sold is provided. The system 100 allows any number of user devices 102 to access a user interface (UI) server 104 via the Internet or otherwise. The UI Server 104 is operable to present information to, and receive information from, the user devices 102 via a two-way communications channel (e.g., a TCP/IP connection). The UI Server 104 is also in two-way communication with an application server 106 operable to execute various modules for performing methods of the invention as described in detail below. The application server 106 is also in two-way communication with each of a database 108, a ticketing system 110, and financial systems 112. The system 100 further includes an operator device 114 in two-way communication with the UI server 104. The user devices 102 and the operator device 114 can be implemented using any processor-based computing device such as a personal computer, laptop, tablet, smartphone, etc. Each of the UI server 104, the application server 106, the database 108, the ticketing system 110, and the financial systems 112 can be implemented using one or more processor-based computing devices. Any of the two-way connections shown between any of the system components can be direct or dedicated secure communications channels or shared indirect secure communications channels such as via the Internet.

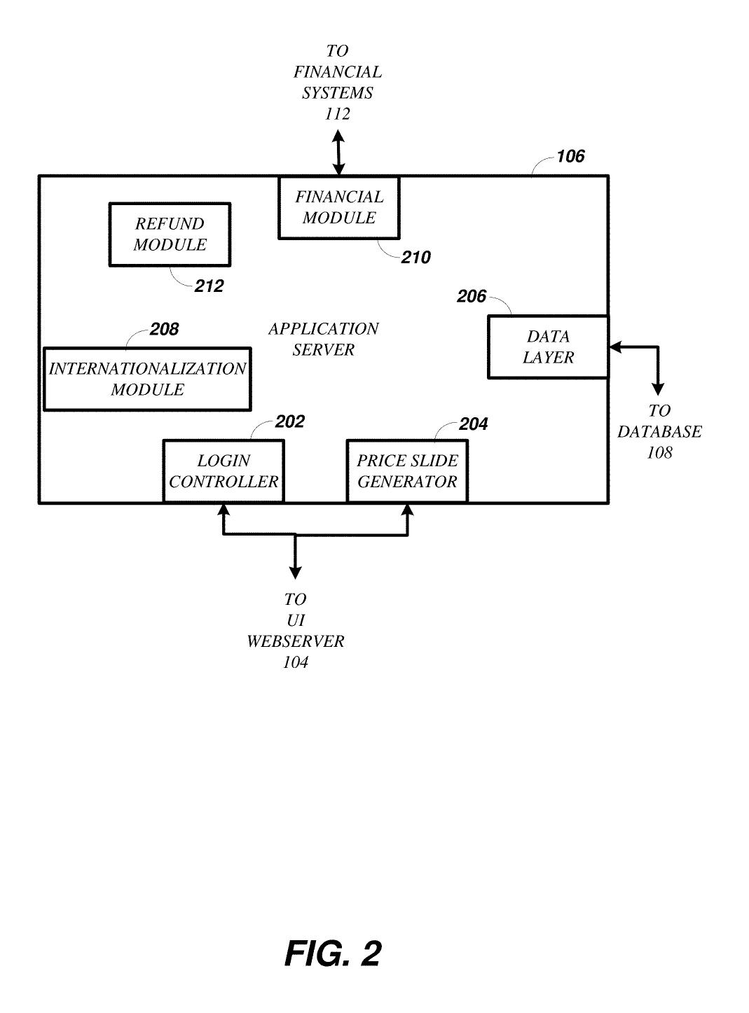

Turning to FIG. 2, details of an example embodiment of the application server 106 are depicted. The application server 106 can include a login controller module 202 for controlling user and operator access to the system 100. The application server 106 can include a price slide generator module 204 for creating the definition or structure of the intended ramp for changing the price of a product as more units are sold. The application server 106 can include a data layer module 206 for storing information such as the definition of the operator's price change ramp and a transaction list that itemizes each purchase by a user in the database 108. In some embodiments, the application server 106 can include an internationalization module 208 for computing currency conversations and retrieving currency exchange rate information from external databases. The application server 106 can include a financial module 210 for interfacing with the financial systems 112 to execute transactions such as charging user financial accounts and refunding the price reductions at the end of the campaign. The application server 106 can include a refund module 212 for computing and verifying the refunds owed to users at the end of a campaign so that the financial module 210 can effect refunds via monetary transfers to user accounts in the financial systems 112.

In operation, the system 100 facilitates three primary processes that can be embodied as example methods of the present invention: (1) creating a promotion, (2) executing a promotion, and (3) settling a completed promotion. Note that while the invention is described as three separate methods here for illustrative purposes, the invention can be practiced as more or fewer methods by subdividing or combining the described methods. In other words, this disclosure is intended to cover any variation of sub-steps and super-steps despite the particular organization described herein which was selected solely for clarity of explanation.

Creating a promotion occurs when an operator (e.g., a vendor or merchant) wishes to create a promotion with an associated price ramp structure and materials describing the goods or services being sold. The method begins with the operator (e.g., via the operator device 114) logging into the UI server 104 using an operator account established upon a first use of the system 100. The login controller 202 will next authorize the operator. The price slide generator 204 via the UI server 104 provides a UI that allows the operator to enter details about the promotion based on, for example historical pricing or other information in the database 108 retrievable via the data layer module 206. Next, the operator creates or configures a financial account (e.g., a bank account) to work with a financial payments platform (e.g., Stripe, Venmo, Zelle, PayPal, etc.) that provides secure, online financial transaction services. Next, the system 100, e.g., via the financial module 210 and the login control 202, associates the operator's financial account with the operator account in the system 100 by utilizing login credentials for the financial account at the operator's financial institution (i.e., financial systems 112) and the database 108. Next, the operator creates “packages” describing the price ramp structure and goods or services being sold utilizing a GUI provided by the UI server 104 described in detail below. In some embodiments, the operator enters any taxes and/or fees in addition to creating several “price points” that define prices that correspond to different numbers of units sold in the system 100. These are entered via UI server 104 and saved in the database 108.

Executing a promotion involves users actually purchasing items offered for sale by the operator (i.e., vendor) and experiencing the excitement of watching the price of the items drop as others purchase the items. Initially, once logged into the system 100, the user requests the current details of a promotion from the UI server 102, which asks the application server 104 to retrieve information from the database 108 to display the current price and other details about a given promotion and packages, and any additional information to be displayed via the UI. The display is dynamic in that the price changes as the user watches the UI which gets updated as “price points” (e.g., a new lower price associated with a higher number of units sold) that alter the price are reached. If the user decides to purchase the item(s), a commit button is provided by the UI to activate. The commit button instructs the UI server 104 to display an interface that provides access to the user's financial institution (i.e., financial system 112). In some embodiments, the user enters their financial institution credentials and payment information directly into the UI which are then forwarded to the financial institution for approval. If the financial transaction is approved, a hold or full charge is placed on the card, and details are stored in the database 108. In some embodiments, a credit hold is used to commit the user to the transaction and the only the final price is later charged when the promotion ends. In some other embodiments, the full amount is charged, and a refund is later issued when the promotion ends. Next, any ticketing information that needs to be generated because of the transaction is then forwarded to the third-party ticketing system 110. Finally, the user is presented with a confirmation and/or ticket if needed. In some embodiments, the user may also be presented with a “share button” that will send information about the promotion and its status e.g., via a link back to the promotion on the UI server 104, with the user's social media or messaging applications.

Settling a completed promotion occurs when the promotion ends and the operator (i.e., vendor) initiates a refund process to ensure all users ultimately pay the same price for the product. The operator logs into the UI server 104 which verifies their account through the application server 106 and database 108. The operator initiates operation of the refund module 212 which calculates the refunds. These are stored in the database 108 for later viewing and verification. In some embodiments, the above steps are executed automatically once the promotion ends. After the refunds are calculated, the operator can view them to verify that they were correctly calculated. If the operator approves the refund calculations, the operator can initiate processing of the refunds. For each refund, the system 100 compares the final price of the promotion to the actual purchase price paid by the user, calculates the difference, and adjusts by either issuing refunds to the users via their financial institution if the users had actually been charged, or effectively converts a hold of the “commit price” to a charge for the final price of the promotion via the financial system 112. The state (or outcome) of this transaction is stored in the database 108. For example, the transaction can be successful or have an error. At this point, the operator can view through the UI, a list of the transactions processed and their state. In some embodiment, additional information from the financial systems 112 can also be stored and/or a reference to data stored in the financial systems 112 can be stored in the database 108.

Additional aspects of embodiments of the invention are now described. The initial request from an operator wanting to design a price ramp structure can be presented to the system 100 through a UI or an API to the price slide generator 204 which can be for information related to pricing, ticketing, or a mix of this information. The system 100 can calculate the current pricing of the items being sold based on sales, price points, time remaining for the promotion, or some combination of such data. During this process, the system 100 may interface with several other subsystems. A third party ticketing system 110 or other third party system (e.g., used to distribute other types of items being sold) for additional data to satisfy the operator's request. As noted above, the system 100 can include a database 108 that stores information relating to the current promotion. In some embodiments, the database 108 can be local, remote and/or a cloud-base datastore. The system 100 can be implemented using one or multiple servers. In some embodiments, the UI webserver 104 can be implemented as a module executing on the application server 106. The UI webserver processes transient data and displays results to the operator.

Once the final price or information by the operator has been requested, this information can be displayed to the operator through either an API or the UI webserver 104 depending on how the request needs to be satisfied. In some embodiments, the user can be a third party website, or a customer wishing to purchase or get additional information on the promotion.

A basic premise of embodiments of the present invention is that all participants will ultimately pay the same price. As an effect of the reduction of the price, the system 100 ensures everyone pays the same price at the end which can be accomplished in several ways. First, the system 100 calculates the final price, which is the price last calculated based on any data the system has which can include time remaining, price points set for the promotion, number of tickets sold, or any combination of the data. One possible way to ensure everyone pays the same price is that all customers are charged using their selected financial instrument the currently calculated price at the time they commit to the purchase. Once the final price is reached, all users are refunded the difference between this final price and the amount that they paid to commit.

Another way to ensure this is that all customers have a hold placed on their financial instrument when they commit to purchase. This hold is then processed for final payment when the final price is reached and the promotion is over. A third way to implement a solution is that when customers commit, they select a financial instrument and prospectively agree to authorize a future charge amount equal to, or less than their commit price. When the final price is reached, all customers are charged the full amount of the final price.

In some embodiments, because the price constantly changes over the course of a promotion, users could be able to select a price at which they would commit if the price reaches the selected price. These future commit users could affect the calculation of the price, and would then join the purchasers using some selected financial instrument as described above.

When operators are creating a promotion, they can potentially enter many price points, which describe conditions that must be reached for a particular price to become valid. This can be based on any data in the system 100, but in the simplest case would be number of units sold and the time remaining in the promotion.

To assist in the creation of this data, the system 100 facilitates the operator creating the promotion to only be required to specify a relatively few price points, and then to specify an algorithmic or mathematic equation (e.g., using a drop-down menu to select) for use by the system 100 for connecting the points together to form the price ramp structure. In the most basic example, the user could enter just two prices and join them together using a linear or logarithmic equation, whereby the system 100 can then generate a number of points without further input from the user.

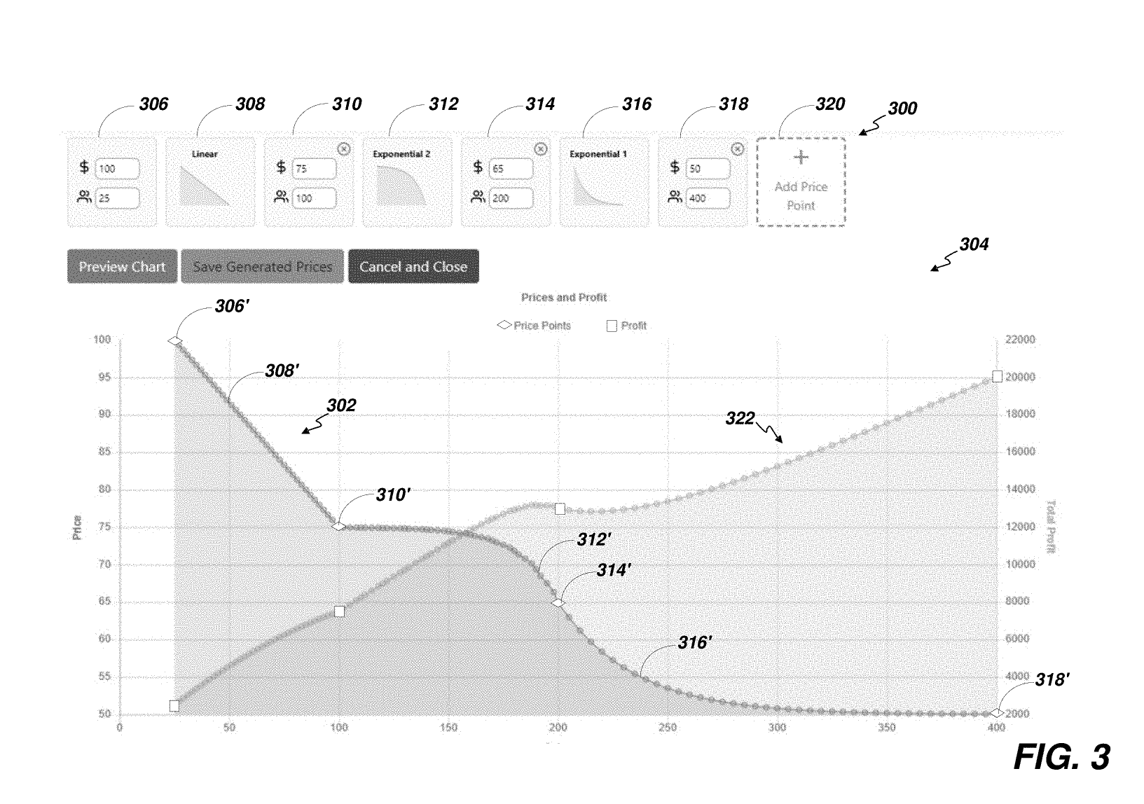

FIG. 3 depicts an example of a GUI 300 presented to the operator by the UI webserver 104 that allows the operator to easily specify, with only a few defining data points, price points used to create the price ramp structure 302 shown in the graph 304 below the GUI 300. The operator uses the GUI 300 to add any desired number of defining price point entry boxes 306, 310, 314, 318 to specify a sales price and a number of units that must be sold to reach each price point 306′, 310′, 314′, 318′. The operator can then use the GUI 300 to select the algorithms or math models 308, 312, 316 that define the curve shape of each corresponding curve segment 308′, 312′, 316′ between the price points 306′, 310′, 314′, 318′. More points can be added using the add price point button 320 and price points can be removed by clicking on the encircled ‘x’ on any of the price point entry boxes 306, 310, 314, 318. In the example, only three illustrative math models 308, 312, 316 (e.g., liner, exponential 1, exponential 2) are shown as selected choices but many more can be offered and selected. In some embodiments, an operator can define their own math model either indirectly via entry of a math expression or directly via dragging GUI control points on the graph 304 to shape the curve 302, for example, with a pointer (e.g., mouse). In some embodiments, the shape of the curve segments 308′, 312′, 316′ can be adjusted during the promotion by dragging portions of them to reshape them. For example, if the rate of sale is not fast enough to satisfy a business goal of the operator (e.g., reach a number of sales milestone by a particular date), the rate of price drop can be increased by distorting the curve segment to fall more steeply.

Note that during a promotion, the price constantly changes throughout the promotion. A distinguishing feature of embodiments of the present invention involves the price changing very frequently during a promotion. This can, in some cases, even cause the price to change for each order or purchase.

In some embodiments, the system 100 can be used to predict price performance, i.e., the expected number of sales for a given price ramp structure. For example, using historical data, it can be useful to predict the future performance of a set of price points. This involves using algorithms or models that look at the rate and resulting revenues of a set of price points (or pricing model) and predicting the change in quantity or velocity of sales based on the rate of change of these price points over the life of the promotion. For example, the promoter would like to have the price change quickly at first, and then slowly near the end to maximize revenues.

Embodiments of the invention provide novel GUI features. When creating price points for a promotion, the operator typically wants to ensure prices meet some business requirement. This may include the desire to visualize the rate at which price points change over the life of the promotion and the associated profits. The profits curve 322 provides profitability feedback in response to adjustments to the price ramp structure. In other words, the graph 304 allows the operator to immediately see the profit impact of making adjustments to the price ramp structure. Note that this feedback can be generated dynamically while the promotion is underway.

When potential customers (i.e., users) of the promotion wish to see the current price and information on a promotion, it is useful to ensure they understand that the price changes based on time remaining and other data. There are several ways this is accomplished to make the system 100 more intuitive to the user. Given that the price constantly changes, it is useful to show this as an animation when the user views the promotion. In some embodiments, this is done by animations such as having a representation of the price that is displayed move down a ramp (e.g., a visualization of the price dropping). In some embodiments, the visualizations are accompanied by audio effects and music to enhance the excitement of the price changes. In some embodiments, this is achieved by animating the value of the price itself, so it reduces quickly and draws attention to the fact that the price has changed since the promotion started. In some embodiments, an audibly ticking clock is also displayed that counts down the remaining time of the promotion. In some embodiments where there are a finite number of items for sale, information can be displayed with the remaining number of items available. In some embodiments, information is displayed that informs the customer the price will change with one or more conditions being met. For example, the user GUI can visually display and/or audibly play the message: “Next price drop with just one more order!” In some embodiments, a cheering sound can be played when the conditions are met and the price drops.

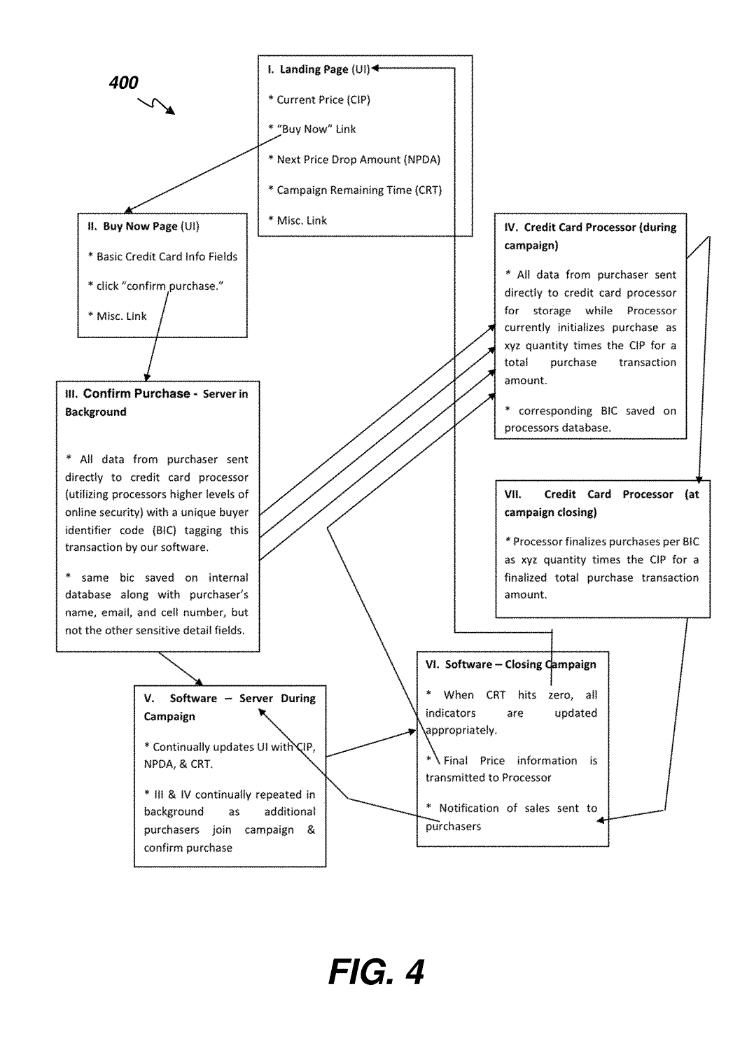

Additional example methods 400 of embodiments of the present invention are illustrated in FIG. 4. In some embodiments, a processor, coupled to a memory, operative to execute stored instructions is provided to allow a seller to perform the following:
1. Set starting price for Promotional Offer.
2. Set duration of Promotional Campaign.
3. Set quantity sold for each price drop point and corresponding price manually.
4. With Add on alternatively use a toolkit to auto set price drops
5. If not already done on seller's own site, provide a description of what item, product or service will be sold (i.e., the promotional Offer).

In some embodiments, a processor, coupled to a memory, operative to execute stored instructions is provided to allow a user or buyer (e.g., purchaser) to perform the following:
1. Purchase a product, service or experience (in response to the promotional offer) at the advertised price within pre-determined timeframe (i.e., during the promotional campaign).
2. Enter all credit card and related information required to make the purchase and optionally receive alerts as long as the campaign is active.
3. Option to Share link via text, social media, or email.
4. After step 2, the credit card will have either a hold or pending charge for the current indicated price, but the final price will be charged at the close of the campaign. In some embodiments, the software can optionally charge the current price and refund the difference to the final at the close of the campaign.

In some embodiments, a processor, coupled to a memory, operative to execute stored instructions is provided to allow a Server (e.g., via software) to perform the following:
1. Collect info from the seller to put a product, service, or experience up for sale on the platform.
2. If not manually entered (and seller selects this option) then software determines different price drops.
3. Facilitates a portion of purchase process in cooperation with credit card processor by producing a database that has a BIC per purchaser which is used to communicate with the processor throughout the transaction though it starts by initializing a credit card hold/charge at the currently indicated price with finalized charge completed corresponding to the final price.
4. Holds data and timer unique to each campaign for transmitting relevant details required when User Interface displays current price (CIP); remaining campaign time (CRT), and quantity required for next price drop (NPDA). (and optionally alerts purchasers, sellers, and potential purchasers).
5. Sends information through credit card processor for finalizing credit card charges.

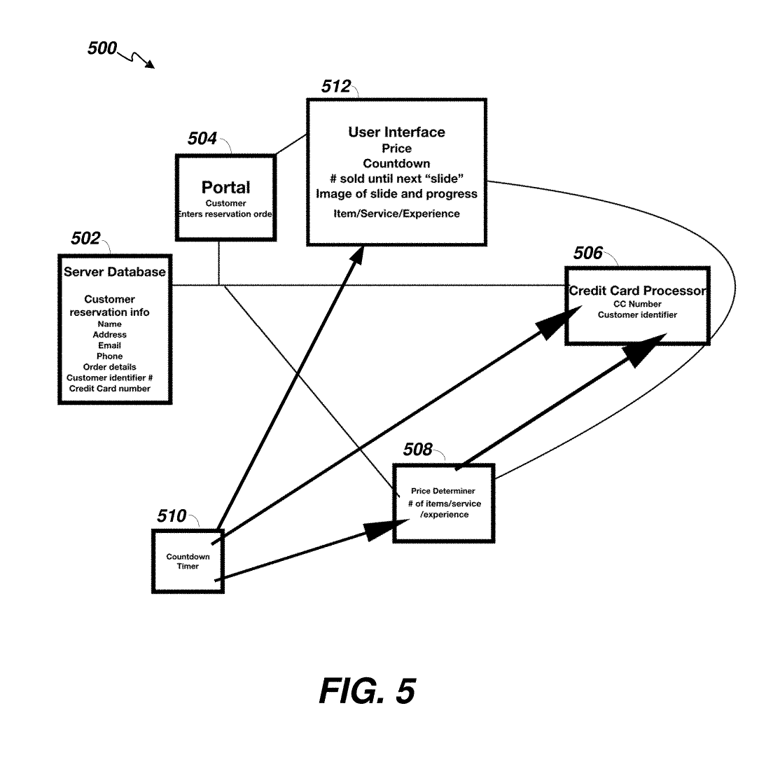

FIG. 5 depicts an example of an alternative architecture of a system 500 for displaying and managing a dynamic price display according to some embodiments of the present invention. Note that the connecting lines between the illustrated modules indicate information flows between the respective modules. Note also that not all modules are necessarily required in all embodiments of the system.

The Server Database system 502 is operative to collect and store customer info to purchase and market products, services or experiences via the customer portal 504 and sends info to credit card processor 506. A Price Determiner module 508 is operable to set prices based off number sold (pre-determined by seller and acted on by purchaser) and sends price to credit card processor 506 to charge.

A Countdown Module 510 tracks and displays the time allowed to purchase set by seller via the user interface 512 and sends action to Price Determiner 508 to stop and send signal to credit card processor 506 to charge the sale. A Credit Card Processor 506 provides a portal used to process payment that receives info from server database 502 and receives price from the Price Determiner module 508 and a signal to run the purchase from countdown module 510.

In some embodiments, the hardware includes web devices (e.g., Mobile, tablet, watch, PC, Laptop or other future web devices); one or more servers to host the Customer Database 502 used to capture and distribute customer information; and an application server operative to run the action steps of the different modules.

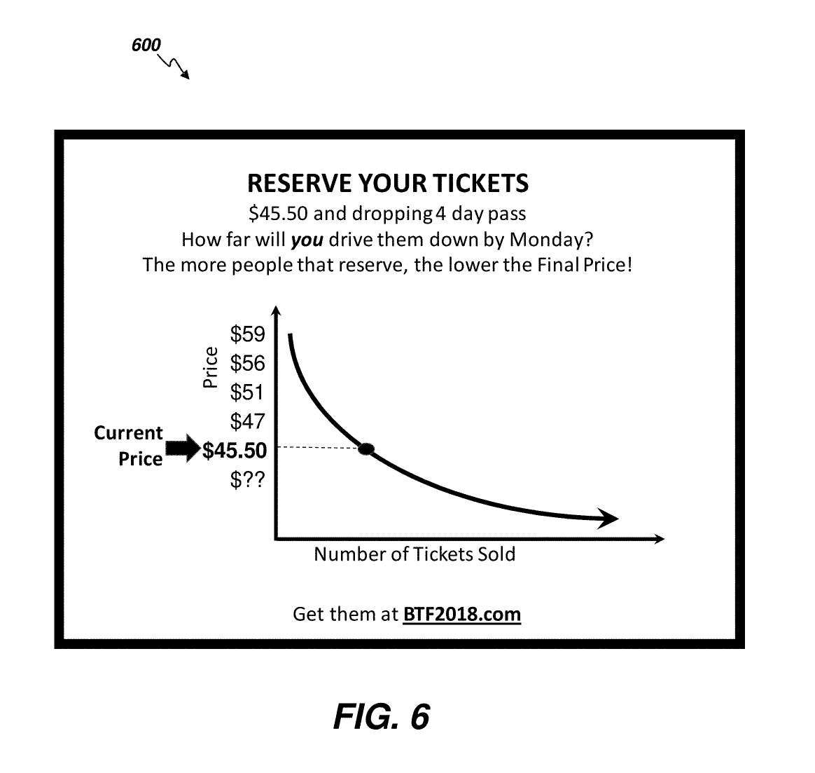

An example User Interface 600 is depicted in FIG. 6 that illustrates a landing page that showing the customer “current price”, the number of items sold until the next “slide” event (i.e., price drop), time left to purchase, and a clickable button to access a customer portal (database).

The following example illustrates another basic embodiment of a dynamic pricing display system and its operation.
1. Dynamic Price Display “Seller Interface”
   a. Create an “Input page” allowing the seller to set a price of a ticket based off the number of tickets sold over a set period of time. (The more tickets sold within the allotted time the more the price dropped down.
   b. Allow for multiple item choices. (two different categories of event tickets, an adult and a junior ticket).
   c. Allow for large number of price break points at which price dropped (e.g., variable increments can be used and/or for a substantial portion of the campaign, the price can be dropped by X dollars for every Y number of tickets sold).
2. Dynamic Price Display “Consumer Interface”
   User Interface
      1. Display current price of offer (tickets).
      2. Thermometer gauge showing sold progress.
      3. Item (ticket) counter until next price drop.
      4. Countdown clock until promotional offer is over (campaign ending time).

As purchasers reserve, a hold is put on their credit card for the agreed on amount at time of reservation. As more purchasers reserve, the reservation price continues to slide (e.g., go down) at the predetermined increments that the “seller” pre-selected. After the allotted time (e.g., 5 days) everyone in the reservation database can be charged the same final amount to which the item (e.g., ticket) price had “slid” (e.g., the initial price may have started at $59 a ticket and slid to a final price of $38.50 a ticket). After the charge is confirmed on the purchaser's card, the corresponding tickets are sent to the customer. Tests of the system reveal a four times sales increase over very predictable “pre-ticket” sales. Some of the reasons for the increased sales are as follows:
1. Customers liked the “together” we get the same price message, “the bigger the group becomes the smaller the price gets for each of us,” or the “more people that join the campaign, the lower the final price.” When these messages were effectively communicated via the interface, the sales rate dramatically increased. In one test, the average sales over previous three years average changed from approximately 1100 tickets sold to 4400 tickets sold using an embodiment of the present invention.
2. The customers share this message with their friends/family on their own. Unlike normal customer incentive programs, this one happens naturally because everyone who already made a purchase is committed and they know they will get “paid” by receiving a benefit or a price reduction, even though they do not know exactly how much while they promote the campaign. Many other incentive programs only confer a benefit if the individual reaches a significant volume of sales or a particular milestone which remains unknown or difficult to attain. According to embodiments of the present invention, the price drops are so frequent and regular, that a person could make their purchase and by the time they refreshed the website, the purchase price can already drop again. Users immediately realize they will get a significant benefit, the only unknown element is how much the benefit will grow.
3. The transaction remains relevant to the customer for the campaign period and people keep returning to the website to see how much the price has dropped.
4. Marketing in this manner is much more effective because the quality of peer driven social media or word-of-mouth is so much higher than purchased advertising. The message gets out to more and more people without having to expend additional resources.
5. The method triggers a natural third-party reference effect without the sponsoring organization coming across in a used car salesman manner or with the tone of shady network marketers. With the current economic environment in marketing where people are bombarded with countless messages, the third party reference effect makes the advertising message rise above the noise.

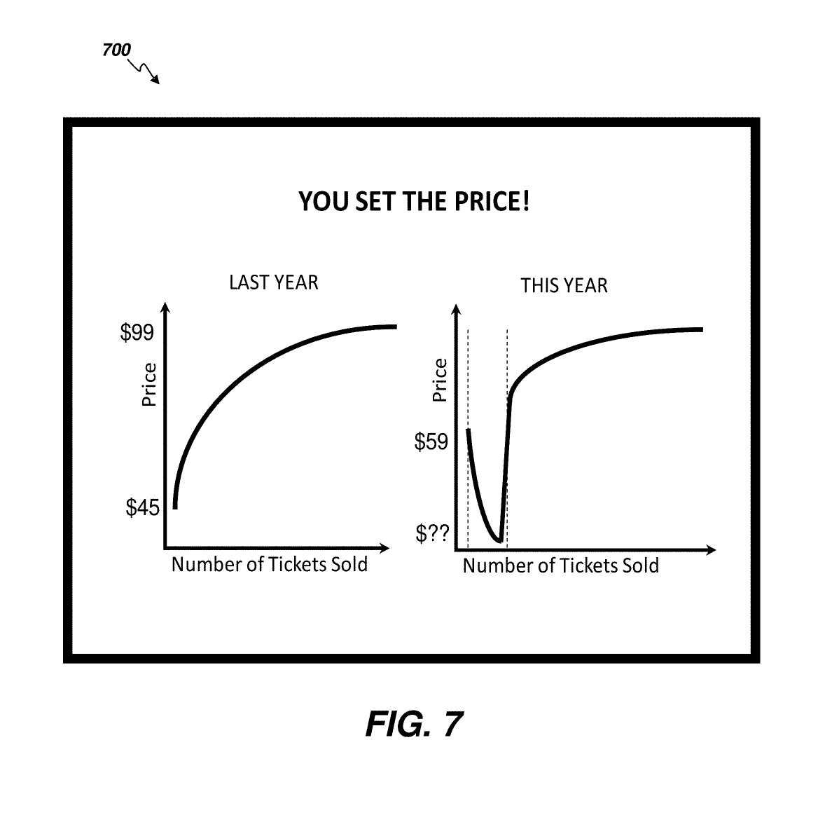

FIG. 7 includes graphs 700 that depict an example display of the number of tickets sold over time and the price from one year to the next.

The above described method steps may be executed or performed in an order or sequence and are not limited to the order and sequence shown and described. For example, in some embodiments, one step may be performed simultaneously with or after another step. In some embodiments, a non-transitory computer-readable medium, such as, e.g., a removable storage disk, memory or device, may include computer readable instructions stored thereon that are capable of being executed by a processor, such as, e.g., a processor in the devices and servers described in FIGS. 1 and 2, to perform steps of the methods described herein.

The foregoing description discloses only example embodiments of the disclosure. Modifications of the above-disclosed assemblies, apparatus, systems, and methods may fall within the scope of the disclosure. Accordingly, while example embodiments of the disclosure have been disclosed, it should be understood that other embodiments may fall within the scope of the disclosure, as defined by the following claim.

The invention claimed is:

1. A system for dynamically displaying and managing the price of an item to be sold, the system comprising:
a processor within an internet accessible server, the processor coupled to a memory, the memory operative to store instructions executable on the processor, the instructions including:
provide a first interface to a seller adapted to allow the seller to define an initial price for the item, price break points, and a sales campaign period;
provide a second interface to a plurality of buyers, the second interface adapted to allow a buyer to commit to purchasing the item at an initial price and a display to indicate a changing price of the item, a rate of change of the price relative to additional buyers committing to purchase the item, and a final price of the item at an end of the sales campaign period; and
provide a transaction system to charge financial instruments of the plurality of buyers to affect the sale of the item to the plurality of buyers at the final price.

2. A method of maximizing profit earned during a sales campaign, the method comprising:
providing a first interface to a seller adapted to allow the seller to define an initial price for an item, price points, and a sales campaign period;
providing a second interface to a plurality of buyers, the second interface adapted to allow a buyer to commit to purchasing the item at an initial price and a display to indicate a changing price of the item, a rate of change of the price relative to additional buyers committing to purchase the item, and a final price of the item at an end of the sales campaign period;
providing a transaction system to charge financial instruments of the plurality of buyers for the item; and
selling the item to the plurality of buyers at the final price.
